(19) United States
(12) Patent Application Publication
(10) Pub. No.: US 2009/0025026 A1
(43) Pub. Date: Jan. 22, 2009

(54) CONDITIONAL RESPONSE SIGNALING AND BEHAVIOR FOR AD DECISION SYSTEMS

(75) Inventors: John R. Mick, JR., Sunnyvale, CA (US); John Pickens, Newark, CA (US)

Correspondence Address: Trellis Intellectual Property Law Group, PC, 1900 EMBARCADERO ROAD, SUITE 109, PALO ALTO, CA, 94303, US

(73) Assignee: CISCO TECHNOLOGY, INC., San Jose, CA (US)

(21) Appl. No.: 11/780,271

(22) Filed: Jul. 19, 2007

(51) Int. Cl. H04N 7/10

(52) U.S. Cl. 725/32

(57) ABSTRACT

In one embodiment, a method can include: (i) receiving a placement opportunity in an ad decision manager (ADM); (ii) sending a request to an ad decision server (ADS); (iii) receiving a conditional response from the ADS, wherein the conditional response includes one or more conditional ads; and (iv) selecting from among the one or more conditional ads.

### TECHNICAL FIELD

The present disclosure relates generally to advertising insertion systems.

### BACKGROUND

Typical advertising or “ad” insertion systems can include ad decision managers (ADM) and ad decision servers (ADS). The ADM can detect pending advertising opportunities, query the ADS for recommended advertising actions, and then control the insertion of the selected advertising content. The ADS can respond to such queries, and provide a list of advertising actions (e.g., play “AD 1” and “AD2”).

In conventional approaches, such decisions may be made either far in advance of the ad placement opportunity, or “just-in-time.” One problem with such decisions in advance is that as the ad placement time approaches, a better choice may emerge (e.g., the sales window has passed, or too many subscribers for that demographic are skipping the ad). One problem with just-in-time decisions involves scaling, where there may not be enough transactions per second capacity to enable clusters of decisions just at the time of ad placement events.

### BRIEF DESCRIPTION OF THE DRAWINGS

FIG. 1 illustrates an example ad placement system.

FIG. 2 illustrates an example ADM to ADS request and conditional response arrangement.

FIG. 3 illustrates an example computational instructions engine usage.

FIG. 4 illustrates examples of ADM and ADS locations.

FIG. 5 illustrates a flow diagram of an example method of ad placement.

FIG. 6 illustrates a flow diagram of an example method of conditional ad evaluation.

### DESCRIPTION OF EXAMPLE EMBODIMENTS

### Overview

In one embodiment, a method can include: (i) receiving a placement opportunity in an ad decision manager (ADM); (ii) sending a request to an ad decision server (ADS); (iii) receiving a conditional response from the ADS, wherein the conditional response includes one or more conditional ads; and (iv) selecting from among the one or more conditional ads.

In one embodiment, an apparatus can include: (i) an ADM configured to receive a placement opportunity, and to provide a selected ad to a content combiner; and (ii) an ADS coupled to the ADM, the ADS being configured to provide a conditional response to the ADM when the ADM issues a request to fill the placement opportunity, the conditional response having one or more conditional ads.

In one embodiment, a method can include: (i) receiving a conditional response having one or more conditional ads; (ii) evaluating a condition of a selected one of the one or more conditional ads; (iii) providing the selected one ad to a content combiner when the condition is met; and (iv) selecting another one of the one or more conditional ads and returning to the evaluating when the condition is not met.

### Example Embodiments

In particular embodiments, a method of enabling an advertising (ad) decision server (ADS) to generate timelier ad placement decisions via a dynamic and conditional mechanism of recommending and recasting ad placement choices may be provided. Such a dynamic and adaptable method can improve the accuracy and value of the ad placement decision, and better adapt to the wide variability of transaction handling rates in systems with widely variable traffic characteristics.

In particular embodiments, an ad decision manager (ADM) processing behavior can be conditionally defined or refined based upon ADS response elements. The conditional response elements can reduce the ADM to ADS processing burden in providing a significantly improved end-user experience via a more responsive system. The conditional response elements can include what-to-do-if, feature-elimination, expiration, and re-query guidance.

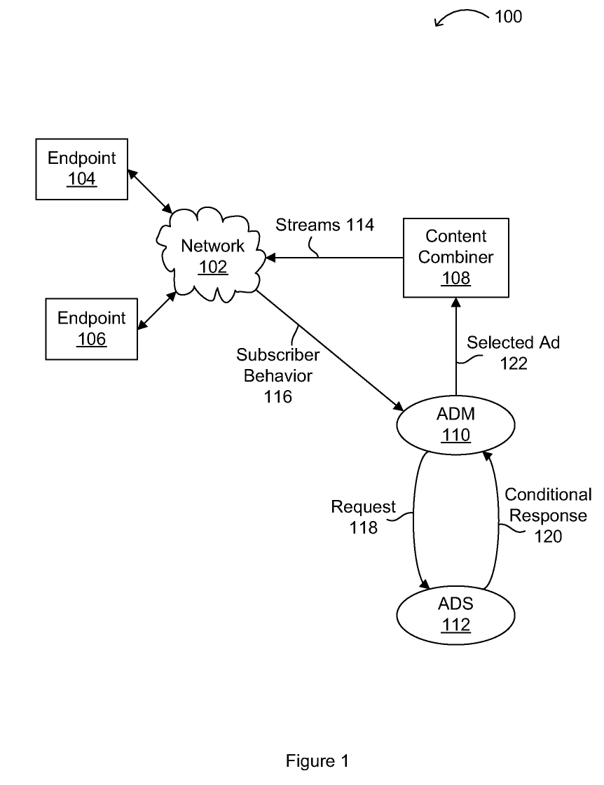

Referring now to FIG. 1, an example ad placement system is shown and indicated by the general reference character 100. Network 102 can interface with endpoints 104 and 106. For example, endpoints 104 and 106 can be set-top boxes (STB), Internet protocol (IP) television (TV) monitors, computing devices, or any suitable devices capable of terminating a content stream (e.g., streams 114). Generally, particular embodiments can apply to any form of audio, video, and/or other media streams, or any type of content distribution involving advertising opportunities, such as across a mobile phone, wireless fidelity (WiFi) device, Internet, cable TV, satellite TV, as well as any way advertising can be inserted (e.g., still pictures, banners, moving pictures, interactive ads, etc.). Further, network 102 can be any type of network, such as a local area network (LAN), wide area network (WAN), wireless fidelity (WiFi), virtual private network (VPN), or the Internet.

Ad decision manager (ADM) 110 and ad decision server (ADS) 112 can represent logical entities or node types communicating via a query or request (e.g., 118) and response (e.g., conditional response 120). Alternatively, asynchronous ADS to/from ADM constructs, as opposed to strictly request-response interaction, can also be supported in particular embodiments. ADM 110 may be stream aware, including which users are active subscribers associated with the stream, characteristics, metadata of the stream, as well as static (e.g., those scheduled well in advance) and dynamic (e.g., based on user actions) factors. Further, ADM 110 can dynamically monitor the video on demand (VOD), linear, or time-shifted play-out behavior of each subscriber (e.g., subscriber behavior 116), or group of subscribers for multicast, served by a content distribution array (e.g., one or more servers that receives input and generates output of VOD, linear, and/or time-shifted multimedia content), and query ADS 112 when an ad placement event is about to occur. Thus, ADM 110 may be aware of placement opportunities (POPs) within a content stream, and targeting criteria for such placement, while ADS 112 can provide ads or rules for performing ad processing operations for insertion or other processing related to the content streams.

The interface between ADM 110 and ADS 112 can be any suitable signaling or targeted advertising systems interface, such as including or complimenting (e.g., via vendor-specific extensions) those that may be described in standards promulgated by the Society of Cable Telecommunications Engineers (SCTE). However, any suitable signaling and/or communication protocol can be utilized for an interface between ADM 110 and ADS 112 in particular embodiments. Generally, such signaling can include a query/request, and a response. Also, ADM 110 may output selected ad 122 to content combiner 108 for inclusion into streams 114. Content combiner 108 may be any device which can insert, delete, and/or replace video and/or audio content within a transmitted multimedia stream. Further, the interface between ADM 110 and content combiner 108 may be any suitable interface. For example, SCTE-30 can be utilized for the interface between ADM 110 and content combiner 108, and the relevant portions of SCTE-30 are incorporated by reference herein.

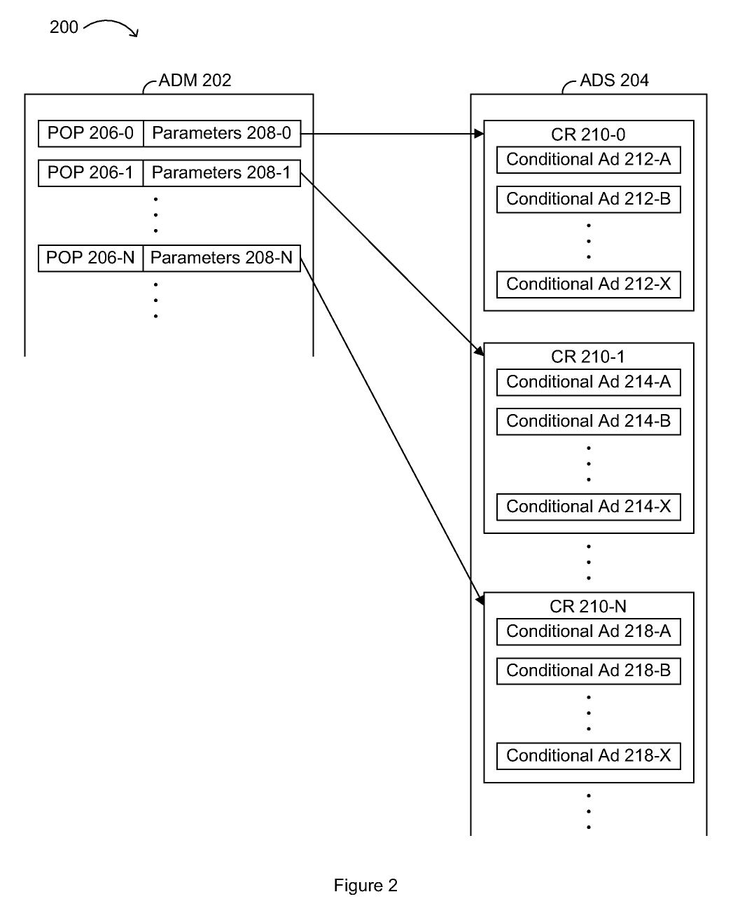

Referring now to FIG. 2, an example ADM to ADS request and conditional response arrangement is shown and indicated by the general reference character 200. ADM 202 can include any number of queries or requests, where each may include a placement opportunity (POP) identifier, as well as any corresponding parameters. For example, ADM 202 can include POP 206-0 with parameters 208-0, POP 206-1 with parameters 208-1, . . . POP 206-N with parameters 208-N, and so on. ADS 204 can include conditional response elements, such as conditional response (CR) 210-0 with conditional ads 212-A, 212-B, . . . 212-X, and corresponding to POP 206-0. Similarly, CR 210-1 with conditional ads 214-A, 214-B, . . . 214-X can correspond to POP 206-1, and CR 210-N with conditional ads 218-A, 218-B, . . . 218-X can correspond to POP 206-N, and so on.

As discussed above, ADS 204 can supply a response to placement requests from ADM 202. In particular embodiments, responses from ADS 204 may be conditional, and parameters including any detectable user action may be utilized in determining a selected ad for placement. Further, conditional instructions or responses can include variations, such as providing a choice of playing one ad for a first time (e.g., 30 seconds), followed by playing another ad for a second time (e.g., 20 seconds), and then returning to the initial ad. As will be discussed in more detail below, a computational instructions engine in, or associated with, ADM 202 can receive conditional response inputs from ADS 204, and may determine a selected ad for placement therefrom. In addition, such conditional responses can include a relatively vast grammar, including if/then/else condition coding, as well as a prioritization of ads, in particular embodiments. Further, instructions or conditional responses may be correlated (e.g., using a conditional instruction ID in the data structure) via subsequent signaling.

Typical parameters supplied in an ADM query can include information about the programming content (e.g., linear program, time-shifted program, stored VOD asset, genres, duration, etc.), information about the user or subscriber (e.g., subscriber identifier, income cluster, age cluster, genre preferences, geographic location, subscriber grouping, etc.), and information about the ad placement opportunity (e.g., a bookend ad, an embedded ad, or a trick mode event such as pause, etc.). Further, conditional instructions can provide secondary or optional behaviors, which may be invoked when predetermined conditions are met. For example, if a user selects pause while viewing a particular ad, or any ad in a series, then the referenced ad spot may be played and included within the directive for this event.

Another type of conditional response or instruction may be to specify a different ad to play if the user selects a particular fast-forward speed. Additional parameters can be included such that the ADM can perform a switch or substitution to a new ad if the normal play time (NPT) is less than 50% of the ad viewing time. These conditional behaviors can reduce or eliminate the ADM having to query or re-query the ADS based on a particular event. Another type of conditional instruction may be to eliminate processing options for the subscriber. For example, prohibiting fast-forward or policy during the ad spot play-out can be accommodated.

Another type of conditional instruction may be an expiration time or re-query time for the placement instruction. The ADS may allow events to occur and may want to change the ad spot if a certain time threshold is exceeded. For example, if ADS 204 selected an ad spot based upon a client's current viewing time, and if the user initiates a pause event for 60 minutes, ADS 204 may wish to change the ad. For example, ADS 204 provides a McDonald's breakfast ad to run because the current client time is well before 11 AM, and the client pauses the system and then hits play again at 11:30 AM. The ADS may now prefer to run the McDonald's lunch ad because McDonald's no longer serves breakfast after 11 AM. The original ad decision can be marked as expiring at 10:50 AM, and ADM 202 can immediately re-query for an update due to the conditional expiration.

In particular embodiments, there may be no limit to the granularity of the conditional behavior specified in the response, nor on the expiration or re-query criteria. However, practical system load limits may reduce the re-query capabilities. Also in particular embodiments, supplying conditional instructions in the response message from an ADS to an ADM can be accommodated. Such conditional instructions can provide behavior definition for expected, but not yet experienced, events (e.g., pause, fast-forward, etc.), or they may serve to disable this type of functionality.

Generally, there may be two classes of rules in particular embodiments. One such class may be unique to a specific ad placement opportunity. Another can be categorized as a group construct. One example of such may be a rule that says “for content-id=x, for any user the default rule is: play ad=y in the first ad opportunity.” Another example can be “for all users that own media centers: play ad=”new media center game x” at least once per day.

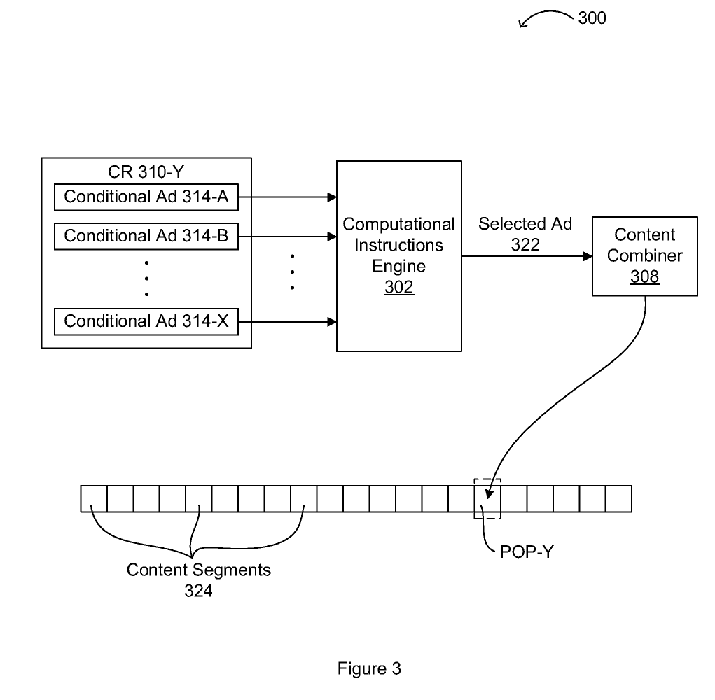

Referring now to FIG. 3, an example computational instructions engine usage is shown and indicated by the general reference character 300. CR 310-Y can include conditional ads 314-A, 314-B, . . . 314-X. These conditional ads can be input to computational instructions engine 302, which can determine selected ad 322 therefrom. Generally, content segments 324 (e.g., video frames) can include placement opportunities, such as POP-Y. As discussed above, the stream-aware ADM can gain knowledge that there is an upcoming opportunity. Then, the ADS can provide conditional ads, with conditions coded therein, to service that opportunity.

Computational instructions engine 302 can make a final decision from among conditional ads supplied by an ADS. This final decision (e.g., selected ad 322) can be provided to a splicer or content combiner 308, and/or the ADM may perform an associated action. For example, selected ad 322 can be combined in a video stream at a frame as identified by POP-Y. Further, content combiner 308 may be a streaming server or video combiner, and can be located at a client (e.g., a set-top box or STB). In such an arrangement, an STB may invoke an ADM function, and/or a decision may be made in an associated network, conditional ads may be propagated to the STB, and the STB can perform the computational/instruction engine operation.

In particular embodiments, an ADS can return placement instructions including the ad spot identifier and ad placement directives, such as: (i) replace an existing ad with an ad of the same size or different size (non-linear on-demand case); (ii) delete an existing ad; (iii) insert a new ad; and/or (iv) present an interactive ad that may result in a subsequent long form ad (long form ad provided by the decision server, or could result in a subsequent query).

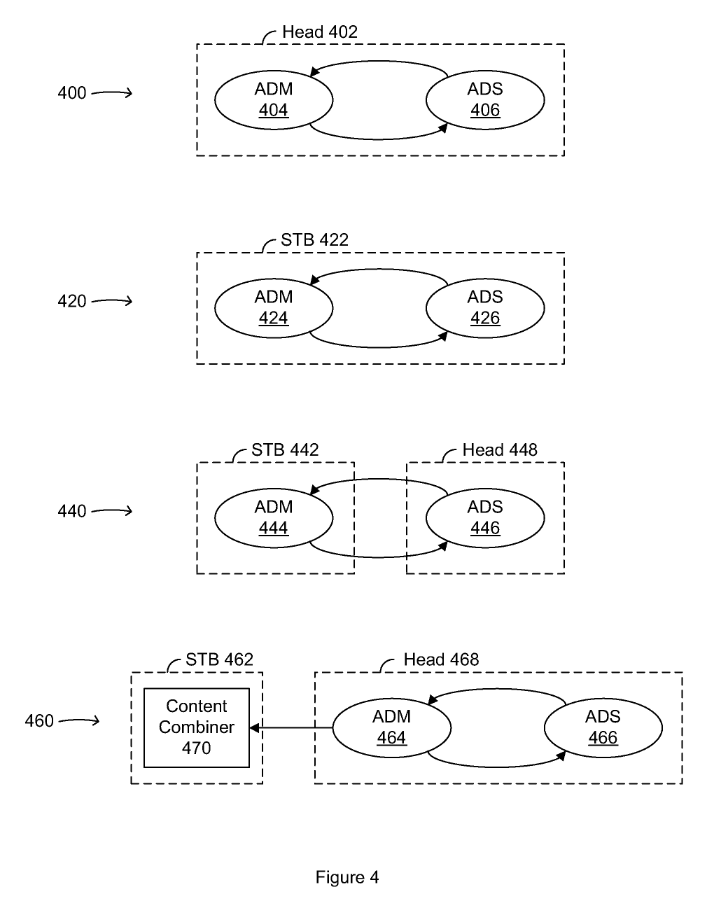

Referring now to FIG. 4, examples of ADM and ADS locations are shown. In one arrangement (400), ADM 404 and ADS 406 may be co-located in a head end or centralized location 402. In another arrangement (420), ADM 424 and ADS 426 may be co-located in STB 422. In another arrangement (440), ADM 444 may be in STB 442, while ADS 446 may be located in head 448. In yet another arrangement (460), ADM 464 and ADS 466 may both be located at the head end 468, but the ADM output of the instruction can be provided to STB 462 for execution via a content combiner 470. Further, particular embodiments may not be limited to an array of content distribution servers. Multiple layers of servers may also exist, such as an ADS coupled to an ADM with embedded ad storage connected to a hardware splicer having logic for detecting actual ad insertion opportunities and splicing of the content.

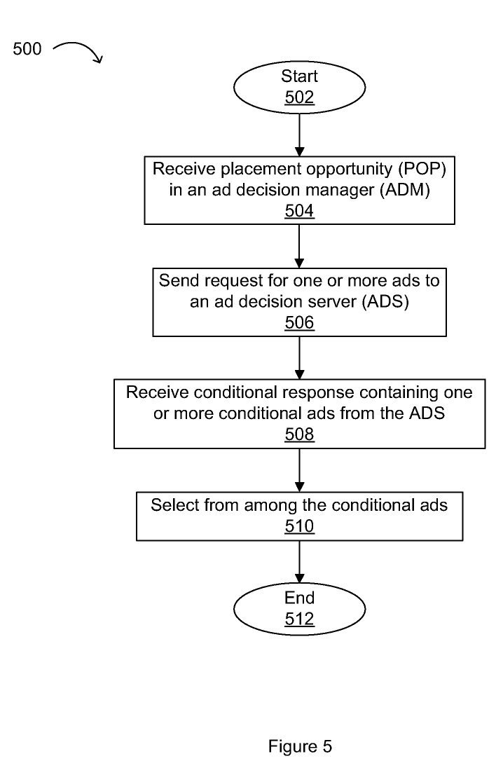

Referring now to FIG. 5, a flow diagram of an example method of ad placement is shown and indicated by the general reference character 500. The flow can begin (502), and a placement opportunity can be received in an ADM (504). A query or request can then be sent for one or more ads to an ADS (506). A conditional response containing one or more conditional ads can then be received from the ADS (508). Then, an ad for placement can be selected from among these conditional ads (510), and the flow can complete (512).

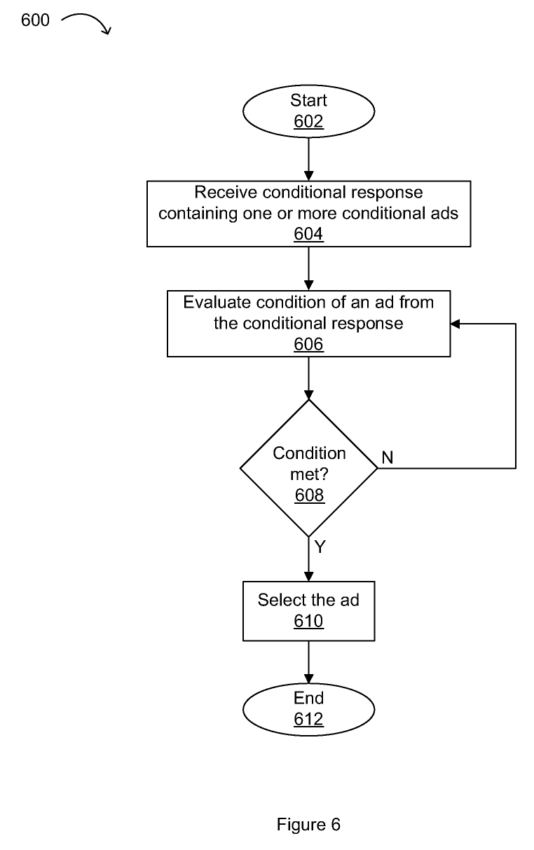

Referring now to FIG. 6, a flow diagram of an example method of conditional ad evaluation is shown and indicated by the general reference character 600. The flow can begin (602), and a conditional response containing one or more conditional ads can be received in an ADM (604). Conditions of an ad from this conditional response can be evaluated (606). If no condition is met in this evaluated ad (608), the flow can return to evaluate a condition for another ad possibility (606). However, if conditions of an ad from the conditional response are met (608), that ad can be selected (610), and the flow can complete (612).

In particular embodiments, a signaling load between the ADS and ADM can be reduced, and earlier decisions can be made with temporal and other behavioral considerations. Conventional systems make such absolute decisions relatively far in advance of the ad placement event, or immediately in the temporal vicinity of the ad placement event. Particular embodiments can generally minimize signaling, maximize scalability, and enable timely and more appropriate ad decisions to be made.

In particular embodiments, temporal ADS processing can be leveraged such that much of the same data may be used for many decisions in an ad placement flow. Accordingly, once the data is obtained, the data may be local to a cache, thus facilitating faster processing and improving scalability. In addition, particular embodiments can provide the ADM system with the capability to respond in real-time to expected but not yet encountered events, which can improve the end-user experience through increased system responsiveness. Further, particular embodiments can allow the ADS to expire time-based behaviors, and for the ADM to re-query for new instructions based upon externally defined conditions.

Although the description has been described with respect to particular embodiments thereof, these particular embodiments are merely illustrative, and not restrictive. For example, while particular ADM and ADS arrangements have been described herein, any suitable arrangement or system model can be accommodated in particular embodiments. Also, while particular examples of conditional responses and query structures have been described, any suitable requests and/or responses having conditions can be utilized in particular embodiments.

Any suitable programming language can be used to implement the routines of particular embodiments including C, C++, Java, assembly language, etc. Different programming techniques can be employed such as procedural or object oriented. The routines can execute on a single processing device or multiple processors. Although the steps, operations, or computations may be presented in a specific order, this order may be changed in different particular embodiments. In some particular embodiments, multiple steps shown as sequential in this specification can be performed at the same time. The sequence of operations described herein can be interrupted, suspended, or otherwise controlled by another process, such as an operating system, kernel, etc. The routines can operate in an operating system environment or as stand-alone routines occupying all, or a substantial part, of the system processing. Functions can be performed in hardware, software, or a combination of both. Unless otherwise stated, functions may also be performed manually, in whole or in part.

In the description herein, numerous specific details are provided, such as examples of components and/or methods, to provide a thorough understanding of particular embodiments. One skilled in the relevant art will recognize, however, that a particular embodiment can be practiced without one or more of the specific details, or with other apparatus, systems, assemblies, methods, components, materials, parts, and/or the like. In other instances, well-known structures, materials, or operations are not specifically shown or described in detail to avoid obscuring aspects of particular embodiments.

A “computer-readable medium” for purposes of particular embodiments may be any medium that can contain, store, communicate, propagate, or transport the program for use by or in connection with the instruction execution system, apparatus, system, or device. The computer readable medium can be, by way of example only but not by limitation, an electronic, magnetic, optical, electromagnetic, infrared, or semiconductor system, apparatus, system, device, propagation medium, or computer memory.

Particular embodiments can be implemented in the form of control logic in software or hardware or a combination of both. The control logic, when executed by one or more processors, may be operable to perform that what is described in particular embodiments.

A “processor” or “process” includes any human, hardware and/or software system, mechanism or component that processes data, signals, or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real time,” “offline,” in a “batch mode,” etc. Portions of processing can be performed at different times and at different locations, by different (or the same) processing systems.

Reference throughout this specification to “one embodiment”, “an embodiment”, “a specific embodiment”, or “particular embodiment” means that a particular feature, structure, or characteristic described in connection with the particular embodiment is included in at least one embodiment and not necessarily in all particular embodiments. Thus, respective appearances of the phrases “in a particular embodiment”, “in an embodiment”, or “in a specific embodiment” in various places throughout this specification are not necessarily referring to the same embodiment. Furthermore, the particular features, structures, or characteristics of any specific embodiment may be combined in any suitable manner with one or more other particular embodiments. It is to be understood that other variations and modifications of the particular embodiments described and illustrated herein are possible in light of the teachings herein and are to be considered as part of the spirit and scope.

Particular embodiments may be implemented by using a programmed general purpose digital computer, by using application specific integrated circuits, programmable logic devices, field programmable gate arrays, optical, chemical, biological, quantum or nanoengineered systems, components and mechanisms may be used. In general, the functions of particular embodiments can be achieved by any means as is known in the art. Distributed, networked systems, components, and/or circuits can be used. Communication, or transfer, of data may be wired, wireless, or by any other means.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/or” unless otherwise indicated. Combinations of components or steps will also be considered as being noted, where terminology is foreseen as rendering the ability to separate or combine is unclear.

As used in the description herein and throughout the claims that follow, “a”, “an”, and “the” includes plural references unless the context clearly dictates otherwise. Also, as used in the description herein and throughout the claims that follow, the meaning of “in” includes “in” and “on” unless the context clearly dictates otherwise.

The foregoing description of illustrated particular embodiments, including what is described in the Abstract, is not intended to be exhaustive or to limit the invention to the precise forms disclosed herein. While specific particular embodiments of, and examples for, the invention are described herein for illustrative purposes only, various equivalent modifications are possible within the spirit and scope, as those skilled in the relevant art will recognize and appreciate. As indicated, these modifications may be made to the present invention in light of the foregoing description of illustrated particular embodiments and are to be included within the spirit and scope.

Thus, while the present invention has been described herein with reference to particular embodiments thereof, a latitude of modification, various changes and substitutions are intended in the foregoing disclosures, and it will be appreciated that in some instances some features of particular embodiments will be employed without a corresponding use of other features without departing from the scope and spirit as set forth. Therefore, many modifications may be made to adapt a particular situation or material to the essential scope and spirit. It is intended that the invention not be limited to the particular terms used in following claims and/or to the particular embodiment disclosed as the best mode contemplated for carrying out this invention, but that the invention will include any and all particular embodiments and equivalents falling within the scope of the appended claims.

We claim:

1. A method, comprising:
receiving a placement opportunity in an ad decision manager (ADM);
sending a request to an ad decision server (ADS);
receiving a conditional response from the ADS, wherein the conditional response includes one or more conditional ads; and
selecting from among the one or more conditional ads.

2. The method of claim 1, wherein the receiving the placement opportunity comprises receiving one or more parameters.

3. The method of claim 2, wherein the sending the request comprises using the one or more parameters, the one or more parameters comprising a user action.

4. The method of claim 1, wherein the conditional response comprises a prioritized ordering of the one or more conditional ads.

5. The method of claim 1, wherein the selecting from among the one or more conditional ads comprises evaluating at least one condition.

6. The method of claim 1, wherein the selecting from among the one or more conditional ads comprises using a computational instructions engine in the ADM.

7. The method of claim 1, further comprising sending the selected ad to a content combiner for providing a content stream to a subscriber.

8. An apparatus, comprising:
an ad decision manager (ADM) configured to receive a placement opportunity, and to provide a selected ad to a content combiner; and
an ad decision server (ADS) coupled to the ADM, the ADS being configured to provide a conditional response to the ADM when the ADM issues a request to fill the placement opportunity, the conditional response having one or more conditional ads.

9. The apparatus of claim 8, wherein both the ADM and the ADS are located in a head end.

10. The apparatus of claim 9, wherein the content combiner is located in a set-top box (STB) at a subscriber end.

11. The apparatus of claim 8, wherein both the ADM and the ADS are located in an STB at a subscriber end.

12. The apparatus of claim 8, wherein the ADM is located in an STB at a subscriber end, and the ADS is located in a head end.

13. The apparatus of claim 8, wherein the ADM comprises a computational instructions engine configured to determine the selected ad from among the one or more conditional ads in the conditional response.

14. The apparatus of claim 8, wherein the ADM comprises one or more parameters for the placement opportunities.

15. A method, comprising:
receiving a conditional response having one or more conditional ads;
evaluating a condition of a selected one of the one or more conditional ads;
providing the selected one ad to a content combiner when the condition is met; and
selecting another one of the one or more conditional ads and returning to the evaluating when the condition is not met.

16. The method of claim 15, wherein the receiving the conditional response is in response to a request to fill a placement opportunity.

17. The method of claim 16, wherein the evaluating the condition comprises utilizing one or more parameters associated with the placement opportunity.

18. The method of claim 17, further comprising deriving at least one of the one or more parameters from a user action.

19. The method of claim 16, wherein the request to fill the placement opportunity is sent from an ad decision manager (ADM) to an ad decision server (ADS).

20. The method of claim 15, wherein the selecting another one of the one of more conditional ads comprises utilizing a prioritized ordering of the one or more conditional ads.
